(19) United States
(12) Patent Application Publication
(10) Pub. No.: US 2018/0132289 A1
(43) Pub. Date: May 10, 2018

(54) Systems and Methods for Improving Support for Data-Oriented Services in a Multi-Subscriber Identity Module (SIM) Wireless Communication Device Having a Designated Data Subscription (DDS)

(71) Applicant: QUALCOMM Incorporated, San Diego, CA (US)

(72) Inventors: Suli Zhao, San Diego, CA (US); Yongsheng Shi, San Diego, CA (US); Qingxin Chen, San Diego, CA (US); Sivaramakrishna Veerepalli, San Diego, CA (US); Li-Ping Shen, San Diego, CA (US); Niranjan Pendharkar, San Diego, CA (US); Yashdev Singh, San Diego, CA (US); Reza Shahidi, San Diego, CA (US); Mona Agrawal, San Diego, CA (US); Bhupesh Umatt, Poway, CA (US)

(21) Appl. No.: 15/345,744

(22) Filed: Nov. 8, 2016

(51) Int. Cl. H04W 76/02; H04W 60/00; H04W 48/10

(52) U.S. Cl. CPC H04W 76/026; H04W 88/06; H04W 48/10; H04W 60/005

(57) ABSTRACT

A multi-subscriber identification module (MSIM) wireless communication device may have at least a first SIM and a second SIM associated with a shared radio frequency (RF) resource. The wireless communication device may detect that the first SIM is set as a designated data subscription (DDS), such that a modem stack associated with the first SIM receives information broadcast by a first network. The wireless communication device may perform a network attach procedure with a second network on a modem stack associated with the second SIM, such that a default packet data network (PDN) connection is established with the second network. The wireless communication device may set the default PDN connection as a persistent PDN connection, with the modem stack associated with the second SIM maintaining at least one persistent PDN connection.

### BACKGROUND

Wireless communication networks are widely deployed to provide various communication services, such as voice, packet data, broadcast, messaging, and so on. Wireless networks may be capable of supporting communication for multiple users by sharing the available network resources. An ongoing goal of mobile communications is achieving high rates of data transmission and reception, while minimizing the amount of power consumed so that wireless communication devices can run longer on a single battery charge. As such, wireless communication devices may operate on networks using Long Term Evolution (LTE) standards that enhance previous telecommunication standards by improving support of mobile broadband Internet access. Such improved support may be based, for example, on increased capacity and speed of wireless data networks, integration with other standards, and multiple-input multiple-output (MIMO) antenna technology.

Increasingly, wireless communication devices employ a variety of methods for achieving network connections, and enable users to access multiple services from different network operators. Since the number and type of devices has grown dramatically, and each device category, manufacturer, and service may have a wide range of device platforms and operating systems, efficiency in providing multiple service configuration options to the same or different users remains important for network operators. Further, streamlining different service configurations on a user device improves the user experience.

Wireless communication devices including more than one subscriber identity module (SIM) have become increasingly popular because of the versatility that such devices provide, particularly in countries where there are many service providers. For example, a multi-SIM multi-standby (MSMS) device enables at least two subscriptions enabled by the multiple SIMs to be in idle mode sharing of a single radio frequency (RF) resource (e.g., transceiver) and waiting to begin communications, but only allows one subscription at a time to participate in an active communication by using the shared RF resource.

### SUMMARY

Systems, methods, and devices of various examples may support packet-switched services in a multi-subscriber identification module (SIM) wireless communication device having at least a first SIM and a second SIM associated with a shared radio frequency (RF) resource. Various examples may include detecting that a first SIM of the wireless communication device is set as a designated data subscription (DDS), in which a modem stack associated with the first SIM receives information broadcast by a first network, and performing a network attach procedure with a second network on a modem stack associated with a second SIM, in which a default packet data network (PDN) connection is established with the second network. Some examples may further include setting the default PDN connection as a persistent PDN connection, in which the modem stack associated with the second SIM maintains at least one persistent PDN connection.

Some examples may further include detecting a request from at least one application to perform an activity using a packet-switched service on the modem stack associated with the second SIM, and allocating use of the RF resource to the modem stack associated with the second SIM. Some examples may further include determining whether a PDN connection corresponding to the packet-switched service associated with the at least one application is established on the modem stack associated with the second SIM, and performing the requested activity in response to determining that a PDN connection corresponding to the packet-switched service associated with the at least one application is established on the modem stack associated with the second SIM. In some examples, the packet-switched service associated with the at least one application is an operator-specific service.

Some examples may further include identifying commonly used PDNs on the modem stack associated with the second SIM, selecting commonly used PDNs to be used for persistent connections in the second network, and establishing persistent PDN connections on the modem stack associated with the second SIM based on the selected commonly used PDNs. Some examples may further include detecting an end of the requested activity, determining whether the PDN connection corresponding to the packet-switched service associated with the request is a persistent PDN connection, and maintaining the corresponding PDN connection on the modem stack associated with the second SIM in response to determining that the PDN connection corresponding to the packet-switched service associated with the request is a persistent PDN connection.

Some examples may further include deactivating the corresponding PDN connection on the modem stack associated with the second SIM in response to determining that the PDN connection corresponding to the packet-switched service associated with the request is not a persistent PDN connection. In some examples, the modem stack associated with the second SIM maintains at least one additional persistent PDN connection. In some examples, maintaining the at least one persistent PDN connection may include establishing one or more Evolved Packet System (EPS) bearer with a commonly used PDN.

Some examples may further include detecting a user input to switch the DDS, evaluating PDN connections on the modem stack associated with the first SIM, starting a DDS-switch guard timer, performing a selective PDN connection deactivation process on the modem stack associated with the first SIM based on the evaluation, detecting that the DDS-switch guard timer is expired or the selective PDN connection deactivation process is complete, and updating the DDS selection in application interfaces on the wireless communication device.

In some examples, evaluating PDN connections on the modem stack associated with the first SIM may include identifying any current PDN connections in the first network, and identifying a set of PDN connections to be maintained on the modem stack associated with the first SIM. In some examples, the set of PDN connections to be maintained may include any connection to an IP multimedia subsystem (IMS) PDN. Some examples may further include determining whether the first network supports access to a packet core over wireless local area network (WLAN), in which the set of PDN connections to be maintained includes any connection to an Internet PDN in response to determining that the first network supports access to a packet core over WLAN. Some examples may further include performing a local release of a bearer context for each remaining PDN connection that is not part of the identified set in response to detecting that the DDS-switch guard timer is expired.

Various examples include a wireless communication device configured to use at least two SIMs associated with a shared RF resource, and including a processor configured with processor-executable instructions to perform operations of the methods described above. Various examples also include a non-transitory processor-readable medium on which is stored processor-executable instructions configured to cause a processor of a wireless communication device to perform operations of the methods described above. Various examples also include a wireless communication device having means for performing functions of the methods described above.

### BRIEF DESCRIPTION OF THE DRAWINGS

The accompanying drawings, which are incorporated herein and constitute part of this specification, illustrate examples of the invention, and together with the general description given and the detailed description, serve to explain the features herein.

FIG. 1A is a communication system block diagram of a network suitable for use with various examples.

FIG. 1B is a block diagram of a network architecture suitable for use with the various examples.

FIG. 2 is a block diagram illustrating a wireless communication device according to various examples.

FIG. 3 is a system architecture diagram illustrating example protocol layer stacks implemented by the wireless communication device of FIG. 2.

FIGS. 4A-4B are process flow diagrams illustrating a method of supporting data-oriented services for a subscription that is not the designated data subscription (DDS) on an MSMS wireless communication device according to various examples.

FIGS. 5A-5B are process flow diagrams illustrating a method of switching the DDS on an MSMS wireless communication device according to various examples.

FIG. 6 is a component diagram of an example wireless communication device suitable for use with various examples.

FIG. 7 is a component diagram of another example wireless device suitable for use with various examples.

### DETAILED DESCRIPTION

The various examples will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The terms “wireless device” and “wireless communications device” are used interchangeably herein to refer to any one or all of cellular telephones, smart phones, personal or mobile multi-media players, personal data assistants (PDAs), laptop computers, tablet computers, smart books, palm-top computers, wireless electronic mail receivers, multimedia Internet enabled cellular telephones, wireless gaming controllers, and similar personal electronic devices that include a programmable processor and memory and circuitry for establishing wireless communication pathways and transmitting/receiving data via wireless communication pathways.

As used herein, the terms “SIM,” “SIM card,” and “subscriber identity module” may interchangeably refer to a memory that may be an integrated circuit or embedded into a removable card, and that stores an International Mobile Subscriber Identity (IMSI), related key, and/or other information used to identify and/or authenticate a wireless device on a network and enable a communication service (i.e., a “subscription”) with the network. Examples of SIMs include the Universal Subscriber Identity Module (USIM) provided for in the LTE 3GPP standard, and the Removable User Identity Module (R-UIM) provided for in the 3GPP2 standard. Universal Integrated Circuit Card (UICC) is another term for SIM. Moreover, a SIM may also refer to a virtual SIM (VSIM), which may be implemented as a remote SIM profile loaded in an application on a wireless device, and enabling normal SIM functions on the wireless device.

The information stored in a SIM enables the wireless device to establish a communication link for a particular communication service or services with a particular network, typically defined by a subscription. The term “SIM” is also used herein as a shorthand reference to the communication service and the network subscription associated with and enabled by the information stored in a particular SIM because the SIM, the communication network, and the services and subscriptions supported by that network correlate to one another. Similarly, the term “SIM” may also be used as a shorthand reference to the protocol stack and/or modem stack and communication processes used in establishing and conducting communication services with subscriptions and networks enabled by the information stored in a particular SIM.

As used herein, the terms “multi-SIM multi-standby communication device” and “MSMS wireless device” may be interchangeably used to refer to a wireless communication device that is configured with more than one SIM and allows idle-mode operations to be performed on two networks simultaneously, as well as selective communication on one network while performing idle-mode operations on at least one other network. A dual-SIM dual-standby (DSDS) communication device is an example of a type of MSMS wireless device.

As used herein, the terms “network,” “system,” “wireless network,” “cellular network,” and “wireless communication network” may interchangeably refer to a portion or all of a wireless network of a carrier associated with a wireless device and/or subscription on a wireless device. The techniques described herein may be used for various wireless communication networks, such as code division multiple access (CDMA), time division multiple access (TDMA), frequency division multiple access (FDMA), orthogonal FDMA (OFDMA), single carrier FDMA (SC-FDMA) and other networks.

In general, any number of wireless networks may be deployed in a given geographic area. Each wireless network may support at least one radio access technology, which may operate on one or more frequency or range of frequencies. For example, a CDMA network may implement Universal Terrestrial Radio Access (UTRA) (including Wideband Code Division Multiple Access (WCDMA) standards), CDMA2000 (including IS-2000, IS-95 and/or IS-856 standards), etc. In another example, a TDMA network may implement Global System for Mobile communication (GSM) Enhanced Data rates for GSM Evolution (EDGE). In another example, an OFDMA network may implement Evolved UTRA (E-UTRA) (including LTE standards), IEEE 802.11 (WiFi), Institute of Electrical and Electronic Engineers (IEEE) 802.16 (WiMAX), IEEE 802.20, Flash-OFDM®, etc. Reference may be made to wireless networks that use LTE standards, and therefore the terms “Evolved Universal Terrestrial Radio Access,” “E-UTRAN” and “eNodeB” may also be used interchangeably herein to refer to a wireless network. However, such references are provided merely as examples, and are not intended to exclude wireless networks that use other communication standards.

The terms “network operator,” “operator,” “mobile network operator,” “carrier,” and “service provider” are used interchangeably herein to describe a provider of wireless communications services that owns or controls elements to sell and deliver communication services to an end user, and provides necessary provisioning and credentials as policies implemented in user device subscriptions.

In current mobile communications, wireless service carriers have standardized a number of techniques for selecting wireless communications systems and obtaining service therefrom, in accordance with preferences of the subscriber's service provider/carrier. Service providers generally enable subscribers to access a network by providing provisioning information to subscriber devices. Typically, such networks may implement one or both of circuit switching and packet switching to provide various services. For example, a circuit-switched domain of a network provides a dedicated connection between end-points, while a packet-switched domain routes data over a shared path base on header information. Various third generation (3G) network standards (e.g., GPRS, EDGE, WCDMA, HSDPA, 1×RTT, EVDO) have been developed to incorporate both packet-switched domains and circuit switched domain. In a conventional 3G network, the circuit-switched domain may be used for real-time services, such as telephone calls, and the packet-switched domain used for IP-based services (“data-oriented services”).

LTE is a mobile network standard for wireless communication of high-speed data developed by the 3GPP (3rd Generation Partnership Project) and specified in its Release 8 document series. In contrast to the circuit-switched model of cellular network standards, LTE has been designed to support only packet-switched services. Data services in LTE may be provided over the Internet, while multimedia services may be supported by the IP Multimedia Subsystem (IMS) framework.

The LTE standard is based on the evolution of the Universal Mobile Telecommunications System (UMTS) radio access through the Evolved Universal Terrestrial Radio Access Network (E-UTRAN). LTE together with the Evolved Packet Core (EPC) network (core network accommodating LTE) make up an Evolved Packet System (EPS). While the access network in UMTS emulates a circuit-switched connection for real time services and a packet-switched connection for data services, the Evolved Packet System (EPS) is purely IP based, and both real time services and data services are carried by the IP protocol. LTE uses Orthogonal Frequency Division Multiple Access (OFDMA) technologies, and is an all-IP system that provides an end-to-end IP connection from the mobile equipment to the core network.

In LTE systems, operators may provide various services through connections with different external packet data networks (PDNs). For example, conventional IP-based applications (e.g. web-browsers, games, e-mail applications, etc.) may be provided in an LTE system as data services over a public internet PDN. Real-time communication services (e.g., voice calls, Short Message Service (SMS) communications, etc.) may be provided in an LTE system through an IP Multimedia Subsystem (IMS) PDN. The IMS architecture allows operators to offer carrier grade services to be offered on packet-switched networks. Examples of services that have been standardized on top of IMS include Open Mobile Alliance (OMA) presence and group list management, Push-to-Talk over Cellular (PoC), Instant Messaging, and TISPAN/3GPP multimedia telephony for IMS (MMTel). Other IMS services that have been developed for deployment as next-generation LTE services include Voice over LTE (VoLTE) and Video Telephony (VT). Additional carrier services (e.g., multimedia messaging service (MMS)), may be provided in an LTE system through separate PDNs (e.g., an MMS PDN). Thus, although LTE data is all IP-based, multiple services may be provided by a network operator.

Modern wireless communication devices may now include a plurality of SIM cards that enable a user to connect to different mobile networks while using the same mobile communication device. Each SIM card serves to identify and authenticate a subscriber using a particular mobile communication device, and each SIM card is associated with only one subscription. For example, a SIM card may be associated with a subscription to one of a GSM, TD-SCDMA, CDMA2000, and/or WCDMA system. Further, multi-SIM operations may be applicable to any of a number of wireless communication systems, using various multiple access schemes, such as, but not limited to, CDMA, FDMA, OFDMA, or TDMA.

Normal RF resource arbitration may be employed to schedule use of a shared RF resource between SIMs on an MSMS wireless communication device. In an MSMS wireless device in which the shared RF resource is used for an active communication on a first SIM (i.e., the subscription enabled by information stored in the first SIM), a second SIM (i.e., the subscription enabled by information stored in the second SIM) may be in an idle mode and not actively contending for access to the RF resource. However, the MSMS device may maintain a connection with a serving network associated with the second SIM in order to perform limited activities (i.e., “idle mode activities”). Depending on the communication protocol, examples of idle mode activities may include monitoring system information, receiving paging messages, measuring signal strength of neighbor cells, etc.

Each SIM in a wireless communication device is configured with its own mobile subscription identification number (MSIN) (also called the mobile identification number (MIN), and/or mobile station identification (MSID)), which is the 10-digit unique number that the wireless carrier uses to identify the device under standards for cellular and PCS technologies. In a multi-SIM wireless communication device, a connection may be established for each SIM in order to enable real-time and/or carrier grade communications associated with each of the different MSINs. Such connection may be, for example, in a circuit-switched domain in various networks, and may be accessed in LTE using circuit-switched fallback.

In contrast, data-centric applications are typically not associated with a particular SIM. Therefore, to access such applications, a data connection needs to be established for only one SIM of the multi-SIM wireless communication device. The SIM or subscription supporting the data connection is referred to as the designated data subscription (DDS). In current MSMS devices, the non-DDS SIM is registered only in a circuit-switched network or domain, and any communication involving a packet-switched network or domain is performed through the DDS SIM. The data connection on the DDS SIM may be a connection in a packet-switched domain of a 3G network, or a bearer context established with a PDN in an LTE network.

The DDS SIM may be selected by a user through a settings menu or other interface on the wireless communication device. The user's selection may be based on any of a number of factors, such as the relative billing rates for data on each SIM. For various reasons, a user may switch the DDS from one SIM to another through the settings menu or other interface on the wireless communication device. For example, the user may choose to switch the DDS upon traveling to a location that is associated with the home network for a non-DDS SIM in order to avoid higher data charges. In another example, the user may switch the DDS from a personal SIM to a workplace-provided SIM if the user needs to use data-oriented services for tasks related to his or her business.

Switching the DDS from one SIM to another typically requires establishing a new data connection on the selected SIM. Specifically, the wireless communication device may register in a packet-switched domain on the modem stack associated with the selected SIM. In an LTE network, such registration may involve performing an initial attach procedure and PDN connection activation.

Further, to conserve network and device resources the existing data connection may instead be deactivated since it will no longer be needed following the DDS switch. Also, the wireless communication device may register in a circuit-switched domain on the modem stack associated with the new non-DDS SIM. However, additional signaling involved in deactivating the existing PDN may introduce a longer delay in switching the DDS, depending on a current context of the SIMs. That is, the DDS switch is associated with over-the-air signaling with the networks to attach and deactivate the packet-switched connections. Consider the following DDS switch scenario 1 (in steps) when the user triggers it via device user interface (UI): i) The UE is in sub 1 DDS and sub 2 non-DDS. ii) The user switches DDS to sub 2; iii) Sub 1 performs a PS detach. iv) DDS switch to sub 2 is triggered; v) Potentially, sub 1 performs CS attach; and vi) sub 2 performs PS attach. Scenario 1 is associated with over-the-air (OTA) signaling with the network for PS de-registration and re-registration. This is expensive and would cause delay. In a 2^{nd} scenario, a device takes the following steps to support PS services on non-DDS sub: i) The UE is in sub 1 DDS and sub 2 non-DDS; ii) MMS or other PS activity may be triggered on sub 2; iii) Sub 1 performs PS detach; iv) A DDS switch to sub 2 is triggered; v) Potentially, sub 1 performs a CS attach; vi) Sub 2 performs a PS attach and a PDN activation; vii) Sub 2 sends/receives MMS; viii) Sub2 performs PS detach after PS activity is complete; ix) DDS switch back to sub1 is triggered; x) Potentially, sub2 performs CS attach; and xi) Sub 1 performs PS attach. As can be seen from scenario 2 the device performs a temporary DDS switch for it to bring up the data connection for PS services on the non-DDS sub, even it is for a short MMS transfer over the non-DDS sub. When LTE+LTE is introduced, non-DDS LTE is inherently a PS RAT over which various PS services (including IMS voice and video telephony, along with other operator services, e.g. MMS, are provided. Therefore, more frequent DDS switches may happen resulting in more signaling overhead and potentially degraded user experience.

While IP-based applications are generally not associated with a particular MSIN, as discussed above, certain applications that use data-oriented services may request activity for a specific MSIN, and therefore require at least temporary access to a data network for the corresponding SIM. If requested for the non-DDS SIM, such access typically involves performing a temporary DDS switch. That is, the modem stack associated with the non-DDS SIM may register for service in the packet-switched domain or network, activating at least one PDN connection if in an LTE network. The modem stack associated with the DDS SIM may deregister the connection in the packet-switched network or domain, including deactivating current PDN connections for an LTE network, and register in the circuit-switched domain. Also, the modem stack associated with the DDS SIM may register in a circuit-switched domain. In this manner, the DDS is temporarily changed, and the requested activity may be performed. Following completion of the activity, the DDS may be changed back to the original DDS SIM by registering (e.g., performing an initial attach procedure) in a packet-switched network or domain, as well as performing any other required procedures to reconnect for data service on the DDS SIM. Further, the wireless communication device may re-register in a circuit-switched domain on the modem stack associated with the non-DDS SIM.

In LTE systems, all services may be configured as packet-switched services. Therefore, while circuit-switched fallback may be used to support carrier services using a 2G or 3G network, operator services in LTE are more efficiently supported using data connections. For example, voice calls may be provided over a connection to an IMS PDN, MMS messages may be provided over a connection to a MMS PDN, etc. That is, applications typically associated with a particular SIM may be provided through packet-switched services. As such, in devices in which the non-DDS SIM is supported by LTE or another all IP-based network, temporary DDS switching may occur frequently, occupying a large amount of signaling overhead. It is proposed to enhance the procedures to facilitate fast DDS switch and fast packet-switched service establishment on non-DDS SIM in a MSMS wireless communication device.

Various examples provide a streamlined process for supporting packet-switched services on a non-DDS SIM, and for performing a DDS switch on a MSMS wireless communication device. In addition to the data connection for the DDS SIM, the wireless communication device may establish and maintain a connection to a data network on the modem stack associated with the non-DDS SIM. For example, the non-DDS SIM may perform a network attach procedure to register in an IP-based network (e.g., an LTE network), which provides IP-connectivity through a default PDN. In this manner, operator provided data services (i.e., service in a packet-switched domain) may be quickly established on the non-DDS SIM. Such quick establishment may reduce delay and improve throughput on the device in which the non-DDS SIM is configured to use LTE or another IP-based radio access technology. Further, maintaining a data network connection on the non-DDS SIM may simplify the DDS switch procedure by performing at least some of the steps (e.g., registering in the packet-switched domain or network, and/or establishing a new PDN connection) in advance of receiving a user input triggering a DDS switch.

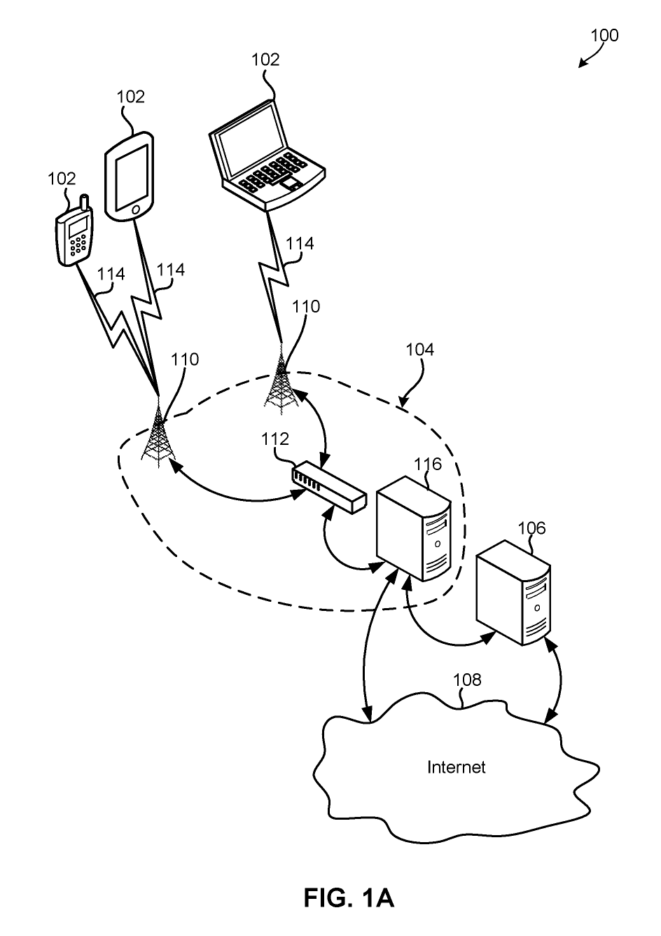

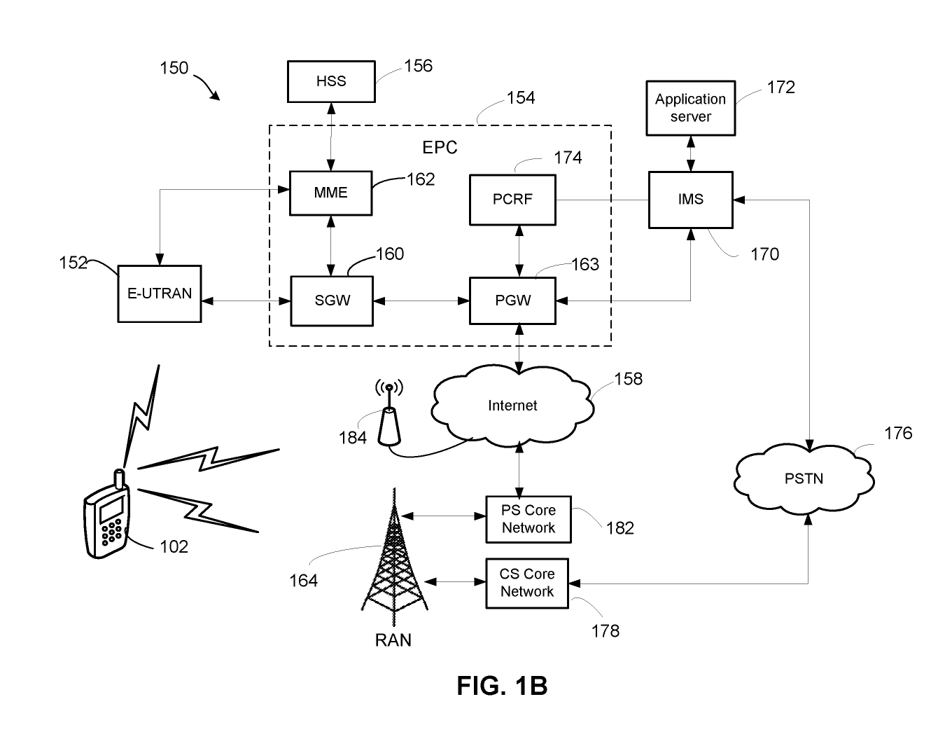

Example processes may be implemented within a variety of communication systems, such as the example communication system 100 illustrated in FIG. 1A. The communication system 100 may include one or more wireless devices 102, a wireless communication network 104, and network servers 106 coupled to the wireless communication network 104 and to the Internet 108. In some examples, the network server 106 may be implemented as a server within the network infrastructure of the wireless communication network 104.

A typical wireless communication network 104 may include a plurality of cell base stations 110 coupled to a network operations center 112, which operates to connect voice and data calls between the wireless devices 102 (e.g., tablets, laptops, cellular phones, etc.) and other network destinations, such as via telephone land lines (e.g., a POTS (plain old telephone system) network, not shown) and the Internet 108. The wireless communication network 104 may also include one or more servers 116 coupled to or within the network operations center 112 that provide a connection to the Internet 108 and/or to the network servers 106. Communications between the wireless devices 102 and the wireless communication network 104 may be accomplished via two-way wireless communication links 114, such as GSM, UMTS, EDGE, fourth generation (4G), 3G, CDMA, TDMA, LTE, and/or other communication technologies.

In general, any number of wireless networks may be deployed in a given geographic area. Each wireless network may support one or more radio access technology, which may operate on one or more frequency (also referred to as a carrier, channel, frequency channel, etc.) in the given geographic area in order to avoid interference between wireless networks of different radio access technologies.

Upon power up, the wireless device 102 may search for wireless networks from which the wireless device 102 can receive communication services. In various examples, the wireless device 102 may be configured to prefer LTE networks when available by defining a priority list in which LTE frequencies occupy the highest spots. The wireless device 102 may perform registration processes on one of the identified networks (referred to as the serving network), and the wireless device 102 may operate in a connected mode to actively communicate with the serving network.

Alternatively, the wireless device 102 may operate in an idle mode and camp on the serving network if active communication is not required by the wireless device 102. In the idle mode, the wireless device 102 may identify all radio access technologies (RATs) in which the wireless device 102 is able to find a “suitable” cell in a normal scenario or an “acceptable” cell in an emergency scenario, as specified in the LTE standards, such as 3GPP Technical Specification (TS) 36.304 version 8.2.0 Release 8, entitled “LTE; Evolved Universal Terrestrial Radio Access (E-UTRA); User Equipment (UE) procedures in idle mode” (May 2008).

FIG. 1B illustrates components of an Evolved Packet System (EPS) network 150. With reference to FIGS. 1A-1B, in the EPS network 150, the wireless device 102 may be connected to a LTE access network, for example, the Evolved UMTS Terrestrial Radio Access Network (E-UTRAN) 152. In the various examples, the E-UTRAN 152 may be a network of LTE base stations (eNodeBs) (e.g., 110 in FIG. 1A), which may be connected to one another via an X2 interface (e.g., backhaul) (not shown). In various examples, each eNodeB in the E-UTRAN 152 may provide an access point to an LTE core network, such as an Evolved Packet Core (EPC) 154. In various examples, the EPC 154 may include at least one Mobility Management Entity (MME) 162, a Serving Gateway (SGW) 160, and a Packet Data Network (PDN) Gateway (PGW) 163. The E-UTRAN 152 may connect to the EPC 154 by connecting to the SGW 160 and to the MME 162 within the EPC 154. The MME 162, which may also be logically connected to SGW 160, may handle tracking and paging of the wireless device 102 and security for E-UTRAN access on the EPC 154. The MME 162 may be linked to a Home Subscriber Server (HSS) 156, which may support a database containing user subscription, profile, and authentication information. Further, the MME 162 provides bearer and connection management for user internet protocol (IP) packets, which are transferred through the SGW 160.

The SGW 160 may route incoming and outgoing IP packets for the wireless device 102 via the LTE access network and external IP networks (i.e., packet data networks (PDNs)). The SGW 160 may also provide an anchor point for handover between eNodeBs. The SGW 160 may be logically connected to the PGW 163, which may route packets to and from PDNs to form a connection between the EPC and various PDNs, for example, IP Multimedia Subsystem (IMS) 170. The IMS 170 may connect with one or more application server 172 to execute IMS specific services. The PGW 163 may be logically connected to a Policy Charging and Rules Function (PCRF) 174, a software component of the EPC 154 that may enforce minimum quality of service parameters, and manage and control data sessions. The PGW 163 may also provide connections with other public or private networks on the Internet 158.

In the various examples, in addition to the LTE access network, the wireless device 102 may be configured to connect independently to various access networks that provide at least voice services through the public switched telephone network (PSTN) 176. For example, the wireless device 102 may connect to a legacy circuit switched (CS) core network 178 through a radio access network (RAN) 164 that provides at least voice service through the PSTN 176. Further, the wireless device 102 may connect through the RAN 164 to a packet switched (PS) core network 182, which may be connected to external PS networks, such as the Internet 158 through a Gateway GPRS support node (GGSN) (not shown).

The wireless device 102 may further connect to other Internet Protocol (IP) based networks, such as a WLAN, over a separate connection to the Internet 158 via an LTE system (e.g., access point 184).

Some or all of the wireless devices 102 may be configured with multi-mode capabilities and may include multiple transceivers for communicating with wireless networks over different wireless links/radio access technologies (RATs). For example, the wireless device 102 may be configured to communicate over multiple wireless data networks on different subscriptions, such as in a dual-SIM wireless device. In some examples, the wireless device 102 may be configured with MSMS capability, which enables a multi-SIM wireless communication device to share a transmit/receive chain and to simultaneously monitor for pages in idle mode until one SIM begins a communication.

For clarity, while the techniques and examples described herein relate to a wireless device configured with at least one LTE subscription, the techniques and examples may be extended to subscriptions on other radio access networks (e.g., UMTS/WCDMA, GSM, CDMA, etc.).

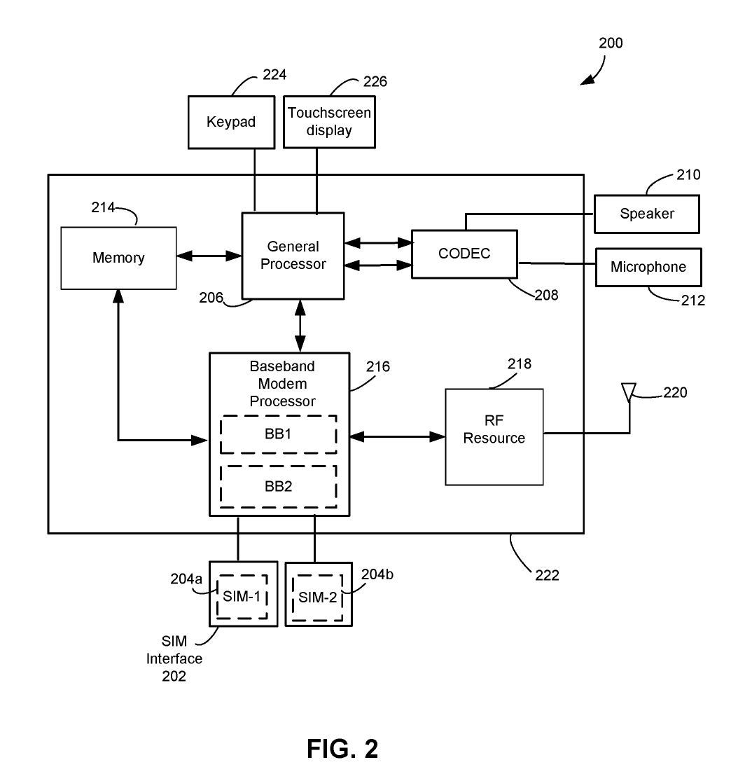

FIG. 2 is a functional block diagram of an example wireless communication device 200 that is suitable for implementing various examples. With reference to FIGS. 1A-2, the wireless communication device 200 may be similar to one or more of the wireless device 102. The wireless communication device 200 may be a multi-SIM wireless communication device, such as an MSMS wireless communication device. The wireless device 200 may include at least one SIM interface 202, which may receive a first SIM (“SIM-1”) 204a that is associated with a first subscription. In some examples, the at least one SIM interface 202 may be implemented as multiple SIM interfaces 202, which may receive at least a second SIM (“SIM-2”) 204b that is associated with at least a second subscription.

A SIM in various examples may be a Universal Integrated Circuit Card (UICC) that is configured with SIM and/or USIM applications, enabling access to GSM and/or UMTS networks. The UICC may also provide storage for a phone book and other applications. Alternatively, in a CDMA network, a SIM may be a UICC removable user identity module (R-UIM) or a CDMA subscriber identity module (CSIM) on a card.

Each SIM 204a, 204b may have a CPU, ROM, RAM, EEPROM and I/O circuits. One or more of the first SIM 204a and second SIM 204b used in various examples may contain user account information, an IMSI a set of SIM application toolkit (SAT) commands and storage space for phone book contacts. One or more of the first SIM 204a and second SIM 204b may further store home identifiers (e.g., a System Identification Number (SID)/Network Identification Number (NID) pair, a Home PLMN (HPLMN) code, etc.) to indicate the SIM network operator provider. An Integrated Circuit Card Identity (ICCID) SIM serial number may be printed on one or more SIM 204a, 204b for identification. In some examples, additional SIMs may be provided for use on the wireless device 200 through a VSIM application (not shown). For example, the VSIM application may implement remote SIMs on the wireless device 200 by provisioning corresponding SIM profiles.

The wireless device 200 may include at least one controller, such as a general-purpose processor 206, which may be coupled to a coder/decoder (CODEC) 208. The CODEC 208 may in turn be coupled to a speaker 210 and a microphone 212.

The general purpose processor 206 may be coupled to at least one baseband-modem processor 216. Each SIM 204a, 204b in the wireless device 200 may be associated with a baseband-RF resource chain that includes at least one baseband-modem processor 216 and at least one RF resource 218. As used herein, the term “RF resource” refers to the components in a communication device that send, receive, and decode radio frequency signals. An RF resource typically includes a number of components coupled together that transmit RF signals that are referred to as a “transmit chain,” and a number of components coupled together that receive and process RF signals that are referred to as a “receive chain.”

The general purpose processor 206 may also be coupled to at least one memory 214. The memory 214 may be a non-transitory tangible computer readable storage medium that stores processor-executable instructions. For example, the instructions may include routing communication data relating to a subscription though the transmit chain and receive chain of a corresponding baseband-RF resource chain. The memory 214 may store operating system (OS), as well as user application software and executable instructions.

In some examples, the wireless device 200 may be an MSMS device, such as a DSDS device, with both SIMs 204a, 204b sharing a single baseband-RF resource chain that includes the baseband-modem processor 216—which may perform baseband/modem functions for communicating with/controlling a radio access technology—and an RF resource 218. In some examples, the shared baseband-RF resource chain may include, for each of the first SIM 204a and the second SIM 204b, separate baseband-modem processor 216 functionality (e.g., BB1 and BB2).

The RF resource 218 may include receiver and transmitter circuitry coupled to at least one antenna 220, and configured to perform transmit/receive functions for the wireless services associated with each SIM 204a, 204b of the wireless device 200. The RF resource 218 may implement separate transmit and receive functionalities, or may include a transceiver that combines transmitter and receiver functions. The RF resource 218 may be configured to support multiple radio access technologies/wireless networks that operate according to different wireless communication protocols. The RF resource 218 may include or provide connections to different sets of amplifiers, digital to analog converters, analog to digital converters, filters, voltage controlled oscillators, etc.

As described above, a wireless communication device in the various examples may support a number of radio access technologies (RATs). For example, the radio technologies may include a wide area network (e.g., using an LTE network, a wireless local area network (WLAN), a Bluetooth network and/or the like). Multiple antennas 220 and/or receive blocks may be provided to facilitate multimode communication with various combinations of antenna and receiver/transmitter configurations.

The baseband-modem processor of a wireless communication device may be configured to execute software including at least one modem stack associated with at least one SIM. SIMs and associated modem stacks may be configured to support a variety of communication services that fulfill different user requirements. Further, a particular SIM may be provisioned with information to execute different signaling procedures for accessing a domain of the core network associated with these services and for handling data thereof.

In some examples, the general purpose processor 206, memory 214, baseband-modem processor 216, and RF resource 218 may be included in a system-on-chip device 222. The first and second SIMs 204a, 204b and their corresponding interface(s) 202 may be external to the system-on-chip device 222. Further, various input and output devices may be coupled to components of the system-on-chip device 222, such as interfaces or controllers. Example user input components suitable for use in the wireless device 200 may include, but are not limited to, a keypad 224 and a touchscreen display 226.

In some examples, the keypad 224, touchscreen display 226, microphone 212, or a combination thereof, may perform the function of receiving the request to initiate an outgoing call. For example, the touchscreen display 226 may receive a selection of a contact from a contact list or receive a telephone number. In another example, either or both of the touchscreen display 226 and microphone 212 may perform the function of receiving a request to initiate an outgoing call. For example, the touchscreen display 226 may receive selection of a contact from a contact list or to receive a telephone number. As another example, the request to initiate the outgoing call may be in the form of a voice command received via the microphone 212. Interfaces may be provided between the various software applications and functions in the wireless device 200 to enable communication between them, as is known in the art.

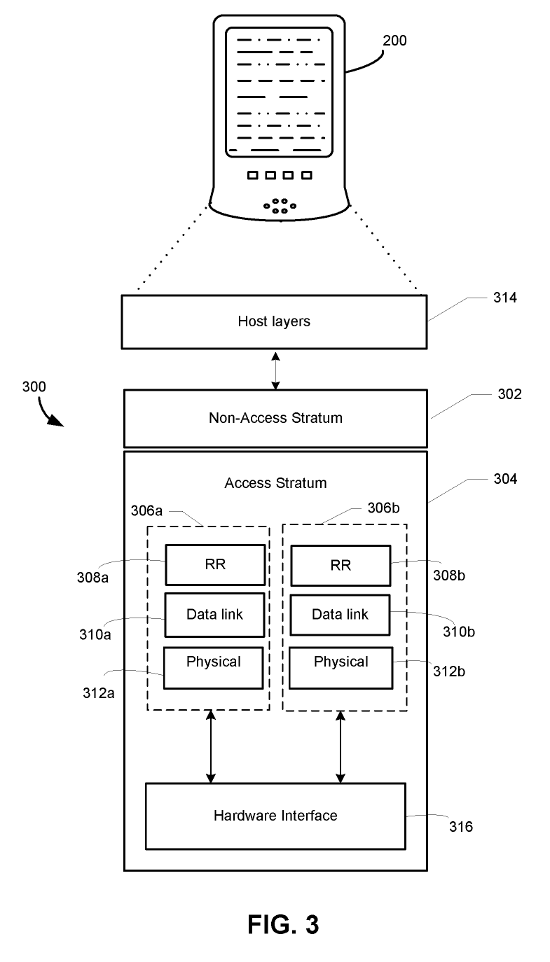

FIG. 3 illustrates an example of a software architecture with layered radio protocol stacks that may be used in data communications on an MSMS wireless communication device. Referring to FIGS. 1-3, the wireless communication device 200 may have a layered software architecture 300 to communicate over access networks associated with SIMs. The software architecture 300 may be distributed among one or more processors, such as baseband-modem processor 216. The software architecture 300 may also include a Non Access Stratum (NAS) 302 and an Access Stratum (AS) 304. The NAS 302 may include functions and protocols to support traffic and signaling each SIM of the wireless communication device 200 (e.g., SIM-1 204a, SIM-2 204b) and their respective core networks. The AS 304 may include functions and protocols that support communication between each SIM (e.g., the SIM-1 204a, SIM-2 204b)) and entities of their respective access networks (e.g., a Mobile Switching Centre (MSC) in a GSM network, eNodeB in an LTE network, etc.).

In the wireless communication device 200, the AS 304 may include multiple protocol stacks, each of which may be associated with a different SIM. For example, the AS 304 may include protocol stacks 306a, 306b, associated with the first and second SIMs 204a, 204b, respectively. Although described below with reference to GSM-type communication layers, protocol stacks 306a, 306b may support any of variety of standards and protocols for wireless communications. In particular, the AS 304 may include at least three layers, each of which may contain various sublayers. For example, each protocol stack 306a, 306b may respectively include a Radio Resource (RR) sublayer 308a, 308b as part of Layer 3 (L3) of the AS 304 in a GSM or LTE signaling protocol. The RR sublayers 308a, 308b may oversee the establishment of a link between the wireless communication device 200 and associated access networks. In the various examples, the NAS 302 and RR sublayers 308a, 308b may perform the various functions to search for wireless networks and to establish, maintain and terminate calls. Further, the RR sublayers 308a, 308b may provide functions including broadcasting system information, paging, and establishing and releasing a radio resource control (RRC) signaling connection between a multi-SIM wireless communication device 200 and the associated access network.

While not shown, the software architecture 300 may include additional Layer 3 sublayers, as well as various upper layers above Layer 3. Additional sub-layers may include, for example, connection management (CM) sub-layers (not shown) that route calls, select a service type, prioritize data, perform QoS functions, etc.

Residing below the Layer 3 sublayers (RR sublayers 308a, 308b), the protocol stacks 306a, 306b may also include data link layers 310a, 310b, which may be part of Layer 2 in a GSM or LTE signaling protocol. The data link layers 310a, 310b may provide functions to handle incoming and outgoing data across the network, such as dividing output data into data frames and analyzing incoming data to ensure the data has been successfully received In some examples, each data link layer 310a, 310b may contain various sublayers, such as a media access control (MAC) sublayer, a radio link control (RLC) sublayer, and a packet data convergence protocol (PDCP) sublayer, each of which form logical connections terminating at the access network. In various examples, a PDCP sublayer may provide uplink functions including multiplexing between different radio bearers and logical channels, sequence number addition, handover data handling, integrity protection, ciphering, and header compression. In the downlink, the PDCP sublayer may provide functions that include in-sequence delivery of data packets, duplicate data packet detection, integrity validation, deciphering, and header decompression.

In the uplink, the RLC sublayer may provide segmentation and concatenation of upper layer data packets, retransmission of lost data packets, and Automatic Repeat Request (ARQ). In the downlink, the RLC sublayer functions may include reordering of data packets to compensate for out-of-order reception, reassembly of upper layer data packets, and ARQ.

In the uplink, the MAC sublayer may provide functions including multiplexing between logical and transport channels, random access procedure, logical channel priority, and hybrid-ARQ (HARQ) operations. In the downlink, the MAC layer functions may include channel mapping within a cell, de-multiplexing, DRX, and HARQ operations.

Residing below the data link layers 310a, 310b, the protocol stacks 306a, 306b may also include physical layers 312a, 312b, which may establish connections over the air interface and manage network resources for the wireless communication device 200. In various examples, the physical layers 312a, 312b may oversee functions that enable transmission and/or reception over the air interface. Examples of such physical layer functions may include cyclic redundancy check (CRC) attachment, coding blocks, scrambling and descrambling, modulation and demodulation, signal measurements, MIMO, etc.

While the protocol stacks 306a, 306b provide functions to transmit data through physical media, the software architecture 300 may further include at least one host layer 314 to provide data transfer services to various applications in the wireless communication device 200. In other examples, application-specific functions provided by the at least one host layer 314 may provide an interface between the protocol stacks 306a, 306b and the general purpose processor 206. In some examples, the protocol stacks 306a, 306b may each include one or more higher logical layers (e.g., transport, session, presentation, application, etc.) that provide host layer functions. For example, in some examples, the software architecture 300 may include a network layer (e.g., IP layer) in which a logical connection terminates at a gateway (e.g., PGW 163). In some examples, the software architecture 300 may include an application layer in which a logical connection terminates at another device (e.g., end user device, server, etc.). In some examples, the software architecture 300 may further include in the AS 304 a hardware interface 316 between the physical layers 312a, 312b and the communication hardware (e.g., one or more RF resource).

In various examples, the protocol stacks 306a, 306b of the layered software architecture may be implemented to allow modem operation using information provisioned on multiple SIMs. Therefore, a protocol stack that may be executed by a baseband-modem processor is interchangeably referred to herein as a modem stack.

The modem stacks in various examples may support any of a variety of current and/or future protocols for wireless communications. For examples, the modem stacks in various examples may support networks using radio access technologies described in 3GPP standards (e.g., GSM, UMTS, LTE, etc.), 3GPP2 standards (e.g., 1×RTT/CDMA2000, EV-DO, UMB, etc.) and/or IEEE standards (WiMAX, Wi-Fi, etc.).

In communications in an LTE network, a wireless communication device (or modem stack associated with a SIM in a wireless communication device) may receive downlink data by decoding packets on the physical downlink shared channel (PDSCH). While a connection with an LTE network may be referred to herein with respect to the wireless device, it will be understood that a connection is established on a modem stack associated with an IMSI (i.e., SIM) in the LTE system. That is, reference to the wireless communication device in various procedures and/or communications with a network may be a general reference to the user equipment associated with a subscription in the network. As such, a SIM transferred to different user equipment may be characterized as the same wireless communication device for purposes of network connections.

When a wireless communication device (or modem stack associated with LTE operations) joins an LTE network, a default bearer may be established in the LTE network (i.e. between the device and the PGW). Without further action, the default bearer remains connected until the wireless communication device detaches from the LTE network. Since each PDN to which the wireless communication device connects is identified by an Access Point Name (APN), a separate default bearer is established, and unique IP address assigned, for each APN. The IP assigned addresses may be, for example, IPv4, IPv6 or IPv4/IPv6 type.

The wireless communication device may access the LTE network (i.e., E-UTRAN) by connecting to a serving cell using a single uplink carrier and single downlink carrier. Such connecting in LTE involves performing an initial access procedure, which may involve steps including cell search and cell selection, derivation of system information, and random access. In various examples, the cell search may involve performing a hierarchical search for LTE radio cells, which are identified by physical cell identities (PCIs). Specifically, the wireless communication device may tune to each supported LTE channel and measure the received signal strength indicator (RSSI) on each. Such channels may be determined based on LTE frequency bands supported by the operator, which may be stored in a SIM or in non-volatile memory on the device. The channels having an RSSI greater than a threshold value may be identified, and the device may decode synchronization and reference signals to find the physical cell identity of each identified channel.

In particular, the wireless communication device may decode the primary synchronization signal (PSS), which is transmitted in the last orthogonal frequency division multiplexing (OFDM) symbol of the first subframe and carries the physical layer identity of the cell. The PSS may be used to achieve time synchronization, to identify the center of the channel bandwidth in the frequency domain, and to determine which of three physical layer identities the cell belongs. That is, PCIs are organized into groups of three, and the PSS identifies the position of the PCI within the group. The wireless communication device may also decode the secondary synchronization symbol (SSS), which is transmitted in the symbol before PSS. The SSS may be used to achieve radio frame synchronization, and find which PCI group is used for the cell. Therefore, using the PSS and SSS, the PCI may be determined for the cell.

The wireless communication device may decode system information blocks (SIBs) to determine the public land mobile network (PLMN) for the identified cell (i.e., in SIB1). As result, the wireless device may develop a list with frequency, PCI, and PLMN of each identified cell, from which a cell may be selected for camping. In particular, the device may find a suitable cell by finding a cell that transmits power strong enough to be detected by wireless device (based on values decoded from SIB), that is not barred, and that has a PLMN matching that of a selected PLMN.

In this manner, the wireless communication device may camp on a serving cell, and transition between two states/modes defined by the RRC protocol; RRC idle mode, and RRC connected mode. In the RRC idle mode, the wireless communication device is not known in the E-UTRAN, but may receive broadcast system information and data, monitor a paging channel to detect incoming calls, perform neighbor cell measurements, and perform cell reselections. In the RRC connected mode the wireless communication device may be able to transmit data to and receive data from the network by an RRC connection established with a serving eNodeB that handles mobility and handovers. Establishing the RRC connection may be initiated, for example, by the wireless communication device following a contention-based random access procedure.

In various examples, the RRC connection setup may involve Signaling Radio Bearer 1 (SRB1) establishment that is described in 3GPP TS 36.331, entitled “Radio Resource Control (RRC); Protocol specification”. The wireless communication device (or modem stack associated with LTE operations) may transmit an RRC Connection Request message to the eNodeB of the corresponding LTE network on the physical uplink shared channel (PUSCH). In response, the eNodeB may transmit an RRC Connection Setup message to the wireless communication device on the physical downlink shared channel (PDSCH). In various examples, the RRC Connection Setup message may contain instructions to apply a default or specific configuration for SRB1.

Upon receiving the RRC Connection Setup message, the wireless communication device may complete the procedure by sending an RRC Connection Setup Complete message to the eNodeB on the PUSCH, and transitioning to the RRC Connected mode. The RRC Connection Setup Complete message may include a message type, a transaction identifier, and a selected PLMN identity, among other information.

Once the RRC connection is established, the wireless communication device may perform a network attach procedure. For example, the wireless communication device may perform Non-Access Stratum (NAS) Attach procedure, which is described in 3GPP TS 24.301, entitled “Non-Access Stratum (NAS) protocol for Evolved Packet System (EPC); Stage 3”. In particular, the wireless communication device (or modem stack associated with LTE operations) may transmit to the eNodeB an initial attach message (e.g., an Attach Request in the NAS procedure) as part of the RRC Connection Setup Complete message. The Attach Request message may be an EPS Mobility Management (EMM) message. Also, a PDN Connectivity Request message, which may be an EPS Session Management (ESM) message, is embedded in the ESM Message Container field of the Attach Request message. In particular, the PDN Connectivity Request message may request a PDN connection on the established RRC connection.

The eNodeB may establish an S1 logical connection with the MME (e.g., 162 in FIG. 1B) for the wireless communication device, extract the PDN Connectivity Request, and forward the PDN Connectivity Request to an MME (e.g., 162 in FIG. 1B) using the S1 Application Protocol (S1-AP). The PDN Connectivity Request message may include information requesting Domain Name Service (DNS) server IP addresses.

Based on a subscription profile received from the HSS (e.g., 156 in FIG. 1B), the MME may send a Create Session Request message to the PGW (e.g., 163 in FIG. 1B) for EPS session creation. Based on a subscription profile received from the HSS (e.g., 156 in FIG. 1B), the Request message may include a PDN type (e.g., IPv4 and/or IPv6), and may include an Access Point Name (APN) identifying the default PDN. The PGW may allocate an IPv6 address and/or IPv4 address to the wireless device, depending on the requested address type. Such allocation may be performed using, for example, using Dynamic Host Configuration Protocol for IPv6 (DHCPv6) or Stateless Address Auto configuration (SLACK) for an IPv6 type address, or DHCPv4 for an IPv4 type address.

The PGW may send a Create Session Response message to the MME that includes the IP address allocated to the wireless communication device (or modem stack associated with LTE operations), as well as the DNS server IP addresses if requested. The MME may request activation of the default bearer context by sending to the wireless communication device, through the eNodeB, an Activate Default Bearer Context Request message that contains the allocated IP address(es) and DNS server IP addresses. For example, the Activate Default EPS Bearer Context Request message may be an ESM message embedded in the ESM Message Container field of an Attach Accept message (i.e., an EMM message) sent from the eNodeB to the wireless communication device. In response, the wireless communication device may transmit an Attach Complete message (i.e., EMM message) to the eNodeB, which may contain an Activate Default EPS Bearer Context Accept message (i.e., ESM message) that is extracted and sent on to the MME. Thus, a default EPS bearer may be established between the wireless communication device and the PGW, allowing the wireless communication device to use the services provided by the PDN.

If the wireless communication device is already attached to the network (e.g. to a default PDN), the wireless communication device may perform additional PDN connection procedures to establish additional PDNs. If in idle mode, the wireless communication device may initiate RRC connection establishment. Once the RRC connection is established, the wireless communication device may transmit the PDN Connectivity Request message to the eNodeB through an Uplink Information Transfer message. The eNodeB may send an RRC Connection Reconfiguration message with Activate Default EPS Bearer Context Request message to the wireless communication device. In response, the wireless communication device may send an Activate Default EPS Bearer Context Accept message to the eNodeB through an Uplink Information Transfer message.

When the wireless communication device (or modem stack associated with LTE operations) no longer requires service, the device may deregister from the LTE network by performing a PDN Disconnect procedure. Specifically, to initiate the PDN Disconnect procedure, the wireless communication device may transmit a PDN Disconnect Request message to the MME through the eNodeB. The PDN Disconnect Request message may contain a value for the linked EPS Bearer Identity, which may be set as the EPS Bearer Identity of the default EPS bearer associated with the PDN for which deactivation is sought. In response, the MME may transmit to the wireless communication device, through the eNodeB, a Deactivate EPS Bearer Context Request message including the linked EPS bearer identity of the default EPS bearer associated with the PDN to be disconnected. Upon receipt of the Deactivate EPS Bearer Context Request message, the wireless communication device may send a Deactivate EPS Bearer Context Accept message to the MME through the eNodeB. In this manner, the S1 connection for the wireless communication device is released by the MME, and the IP address(es) that were assigned for the deactivated PDN are returned to the LTE network.

As described, in a wireless communication device in which multiple SIMs support LTE, the modem stack associated with each LTE SIM may have a connection to at least a default PDN provided by an LTE network. In some examples, the modem stacks associated with the LTE SIMs may access PDNs provided by different LTE networks. In some examples, the modem stacks associated with the LTE SIMs may all access PDNs provided by one LTE network.

When the wireless communication device is operating with a particular SIM as the DDS (sometimes referred to herein as a “first SIM”), a trigger for setting up a data connection on a non-DDS SIM (sometimes referred to herein as a “second SIM”) may be detected. For example, such trigger may be, the user's selection of the second SIM as the DDS, which requires a transfer of data-oriented traffic from the modem stack associated with the first SIM to that of the second SIM. Another example of the trigger may be request for activity requiring a packet-switched service associated with the second SIM. Therefore, a new data connection may be established between the modem stack associated with the second SIM and a packet-switched network or domain supported by a modem stack associated with the second SIM. In an LTE system, creating the new data connection may involve RRC connection setup, followed by performing a network attach procedure (e.g., a NAS Attach Procedure). If triggered by a request requiring a packet-switched service associated with the second SIM, creating the new data connection may also cause a connection with a corresponding PDN (e.g., IMS, MMS, etc.) to be established.

Further, to set up the new data connection, the modem stack associated with the first SIM may be disconnected from the current data network. For example, in an LTE network one or more existing PDN connection may be deactivated, and the modem stack associated with the first SIM deregistered from the network using the PDN Disconnect procedure described. However, establishing and disconnecting new connections with data networks may involve substantial signaling overhead if performed often, such as when the user frequently requests a DDS switch and/or the non-DDS SIM supports an IP-based system.

To address these issues, in various examples, the wireless communication device may implement improved protocols for establishing packet-switched services on a non-DDS SIM configured to use an IP-based network, and for switching the DDS in response to a user input. In particular, the wireless communication device may register with the IP-based network (e.g., LTE) on the modem stack associated with the non-DDS SIM by performing a network attachment procedure, thereby establishing a connection to a PDN identified by a default APN. That is, in devices in which both the DDS SIM and non-DDS SIM support LTE (or LTE and another radio access technology, for example, WCDMA, future fifth generation (5G), etc.), the non-DDS SIM is always attached to a packet-switched network. Therefore, in various examples, the wireless communication device may prepare for packet-switched service requests on the non-DDS SIM by maintaining a default PDN connection on the modem stack associated with the non-DDS SIM. So configured, when a packet-switched service is requested for activity on the non-DDS SIM, the wireless communication device already has IP-connectivity through the network registration, and needs only to activate a new PDN connection corresponding to the requested service. Examples of such new PDN connections may be, for example, with an IMS PDN if the requested service is VoLTE or Video-over-LTE, with a MMS PDN if the requested service is MMS, etc. In other words, when the non-DDS SIM needs to perform a packet-switched call, the wireless communication device only needs to activate the corresponding PDN. The packet-switched activity may then be performed on the non-DDS SIM, and the corresponding PDN may be deactivated. That is, the corresponding PDN connection may be deactivated once the packet-switched service activity is complete, while the modem stack associated with the non-DDS SIM may remain attached to the IP-based network (i.e., connected to the default PDN).

In some examples, the modem stack associated with the non-DDS SIM may further prepare for packet-switched service requests by maintaining connections to certain commonly used PDNs (“persistent PDN connections”). A persistent PDN connection may be activated by establishing at one or more EPS bearers with a commonly used PDN. The specific commonly used PDNs to which the modem stack associated with the second SIM maintains persistent PDN connections may depend on a balance of various factors, including the frequency of requests for packet-switched services that use the PDN, whether the type of packet-switched services supported are real-time and/or carrier grade services, etc. In some examples, the wireless communication device may weigh the impact of the overhead signaling required to establish a connection with a commonly used PDN against the network and device resources required to maintain the PDN connection. Therefore, when a packet-switched service is requested for activity on the non-DDS SIM, the wireless communication device may already have IP-connectivity, as well as an established connection to the corresponding PDN, thereby removing the need for any additional signaling. Upon completion of the packet-switched service activity, the corresponding PDN connection may be maintained if set as a persistent PDN connection, thereby providing an “always-on” status for certain types of packet-switched services (e.g., an Internet PDN). In other words, there may not be a need to bring up PDNs when packet-switched activities are needed on non-DDS SIM. When a packet-switched activity is requested on the non-DDS SIM, packet-switched traffic may be sent and received by the modem stack associated with the non-DDS SIM if the corresponding PDN is already activated. Thus, the non-DDS sub may always maintain commonly used PDNs, e.g., the Internet PDN.

Such continual network attachment and activation of persistent PDN connections may also improve the process for switching the DDS from the current DDS SIM to the non-DDS SIM. Specifically, if a DDS switch is triggered, the wireless communication device may already have IP-connectivity through the network registration on the modem stack associated with the current non-DDS SIM, as well as at least one persistent PDN connection already activated (i.e., established). Therefore, switching the DDS may not require any signaling with the network, and instead may be accomplished by updating DDS settings and routing tables in application interfaces on the wireless communication device.

Accordingly, the various examples may reduce signaling overhead for invoking packet-switched services on the non-DDS SIM by avoiding repeated rounds of network attachment and release, as well as PDN connection activation and deactivation. In this manner, efficiency may be improved and delay to the user minimized. Further, a user-triggered DDS switch may be made seamless by at least one PDN connection being established in advance on the non-DDS SIM, thereby requiring only a change in DDS settings in application interfaces and routing information once a DDS switch is requested.

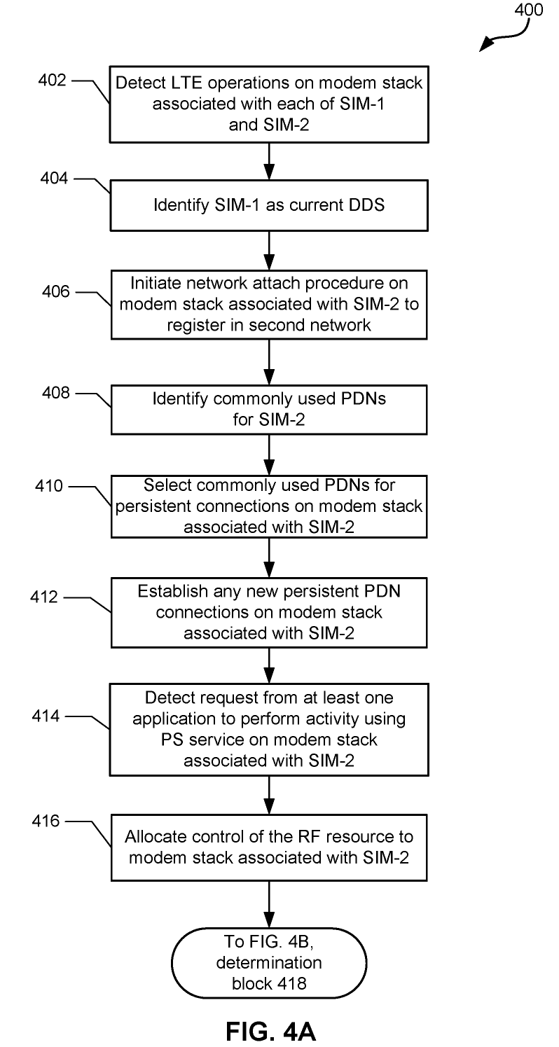

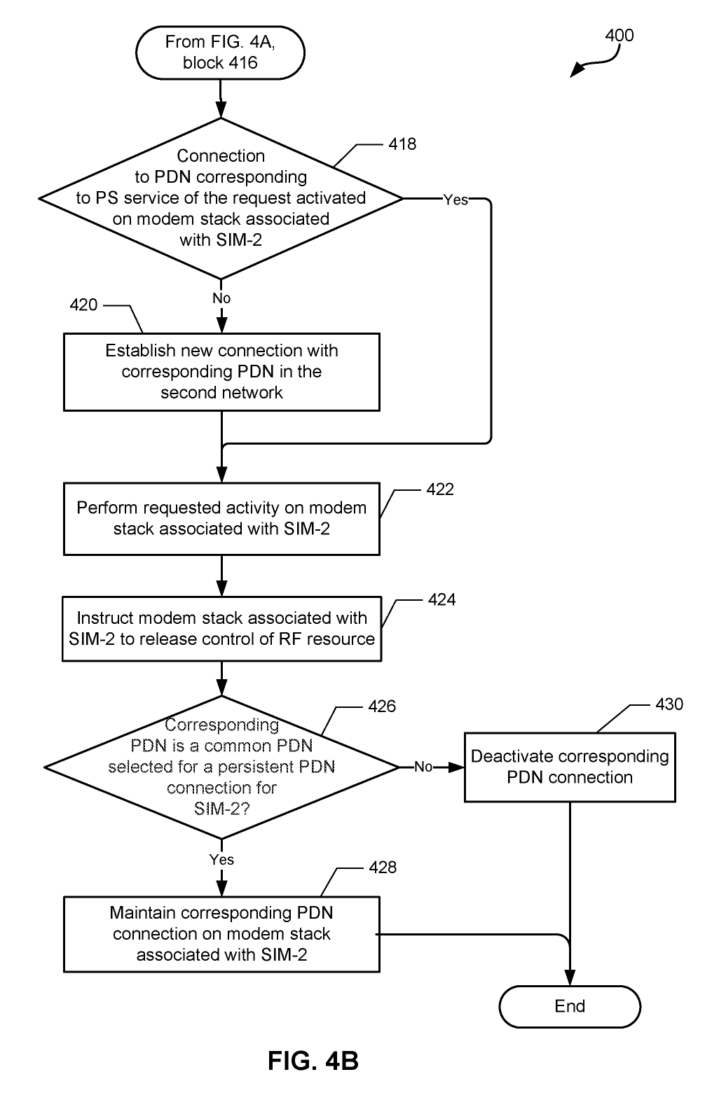

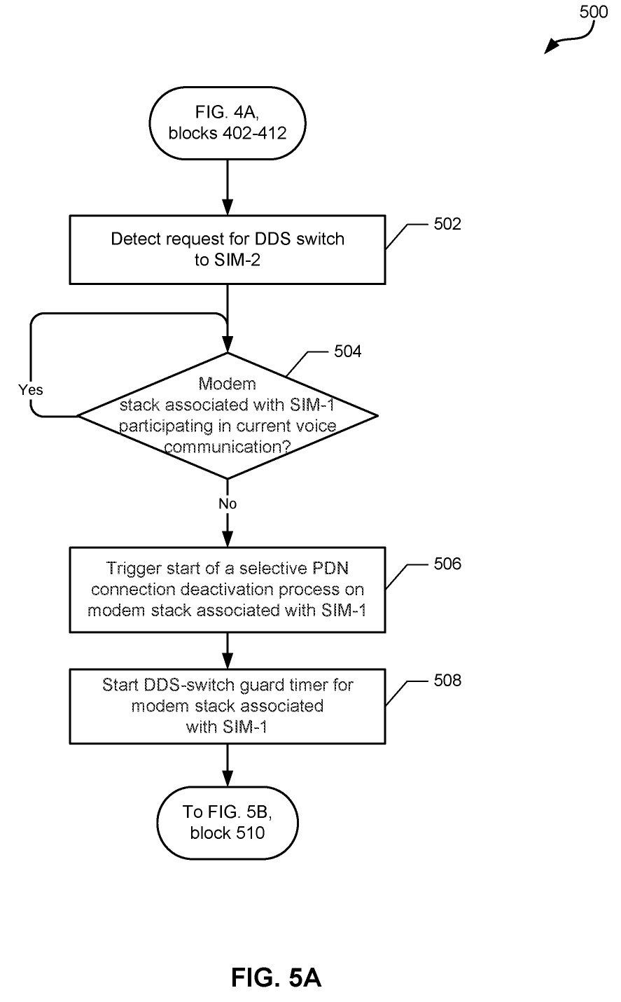

FIGS. 4A-4B illustrate a method 400 for implementing an improved protocol to establish packet-switched (PS) services on a non-DDS SIM of an MSMS wireless communication device according to various examples. With reference to FIGS. 1-4B, the operations of the method 400 may be implemented by one or more processors of a wireless device, such as the wireless communication device 200. The one or more processors may include, for example, a general purpose processor 206 and/or a baseband modem processor(s) 216, or a separate controller (not shown) that may be coupled to the memory 214 and to the baseband modem processor(s) 216.

While the descriptions of the various examples address PDN connections for two SIMs associated with one RF resource, the various example processes may be implemented for SIM functions on more than two SIMs (e.g., three SIMs, four SIMs, etc.). Further, the use of more than two SIMs in various examples may involve sharing more than one RF resource (e.g., two shared RF resources, three shared RF resources, etc.).

In block 402, the wireless device processor may detect LTE operations on a modem stack associated with a first SIM (“SIM-1”) and a modem stack associated with a second SIM (“SIM-2”). As described, the wireless communication device (e.g., 102, 200) may be a MSMS wireless device in which at least two SIMs configured to access LTE network(s) share a single RF resource, taking turns to conduct wireless communications. In various examples, the LTE operations detected on the modem stack associated with the first SIM may be in an LTE network supported by the first SIM (“first network”), while the detected LTE operations for the second SIM may be in an LTE network supported by the second SIM (“second network”). In some examples, the first and second networks may be the same LTE network, while in some examples the first and second networks may be different networks that use LTE standards (i.e., two different networks that are both LTE networks.)

References to the first SIM (“SIM-1”) and the associated modem stack, and the second SIM (“SIM-2”) and the associated modem stack are arbitrary and used merely for the purposes of describing the examples. The wireless device processor may assign any indicator, name, or other designation to differentiate the SIMs, associated modem stacks, and network resources. Further, example methods may apply the same regardless of the mobility state of each SIM and/or communication activity on the modem stack associated with each SIM.

In block 404, the wireless device processor may identify a first SIM that is the current DDS on the wireless communication device. As described, the DDS may be a SIM chosen by a user through device settings presented in a user interface. In various examples, the user may be prompted to select a DDS when the device is powered on, and/or once more than one SIM becomes synchronized with an LTE network. In various examples, the wireless communication device may have registered in the first network by performing a network attach procedure on the modem stack associated with the first SIM, thereby establishing a default PDN connection to the first network.

In block 406, the wireless device processor may initiate a network attach procedure on the modem stack associated with the second SIM in order to register in the second network. In various examples, if the modem stack associated with the second SIM is in an RRC idle mode, the wireless communication device may first trigger an RRC connection setup on the modem stack associated with the second SIM. Once in RRC connected mode, the wireless communication device may perform the network attach procedure, which establishes a bearer path to a default PDN designated by the network operator. In this manner, basic IP-connectivity is enabled for the second SIM through the default PDN connection.

In block 408, the wireless device processor may identify commonly used PDNs for the second SIM. Such identification may be based, for example, on a pre-defined list established by the network operator and/or stored on the second SIM. In some examples, the identification of commonly used PDNs may be based on information collected during previous communications on the modem stack associated with the second SIM, and therefore may change over time.

In block 410, the wireless device processor may select one or more of the commonly used PDNs for persistent connections on the modem stack associated with the second SIM. As described, whether a commonly used PDN is used for a persistent PDN connection may be based on weighing a number of factors that compare the reduction in latency and signaling overhead to the use of additional resources. Therefore, in some examples, no commonly used PDNs may be selected, while in others all of the identified commonly used PDNs may be selected.

In block 412, the wireless device processor may establish any persistent PDN connections on the modem stack associated with the second SIM. In various examples, establishing such connections may be based on which, if any, identified commonly used PDNs are selected (e.g., in block 410). Therefore, in some examples, no persistent PDN connections may be established, while in other examples multiple persistent PDN connection may be established. Each persistent PDN connection may be at least one bearer (e.g., EPS bearer) to a commonly used PDN. Depending on the default PDN connection already established and the requirements for various packet-switched services, establishing a persistent PDN connection may involve activating at least a default bearer with an additional PDN, establishing a new bearer (i.e., dedicated EPS bearer) with the default PDN, or maintaining the existing bearer(s) with the default PDN.

In block 414, the wireless device processor may detect a request from at least one application to perform an activity using a packet-switched service on the modem stack associated with the second SIM. In various examples, the requested activity may be specific to an operator service application using the modem stack associated with the second SIM, and therefore cannot be performed on the DDS SIM (i.e. the first SIM). For example, the wireless device processor may detect input or signaling to trigger an MMS message, voice call, or other communication for the second SIM.

In block 416, the wireless device processor may allocate control of the RF resource to the modem stack associated with the second SIM. That is, control of the RF resource may be transferred to the modem stack associated with the second SIM in order to perform the requested activity using the associated packet-switched service. In various examples, the first network may support the use of wireless local access networks (WLAN), such as Wi-Fi networks, to access the EPC, thereby providing 3GPP services over WLAN through a local breakout. Since the wireless access resource (e.g., Wi-Fi radio) is separate from the RF resource on the wireless communication device, in some examples the modem stack associated with the first SIM may retain internet connectivity when the RF resource is allocated to the modem stack associated with the first SIM. In examples in which the first network does not support a WLAN local breakout, internet service on the modem stack associated with the first SIM may be suspended while the RF resource is allocated to the second SIM.

In determination block 418, the wireless device processor may determine whether a connection to the PDN corresponding to the packet-switched service of the request is activated on the modem stack associated with the second SIM. For example, if the requested activity is an MMS message, the wireless device processor may determine whether a connection to the MMS PDN has been established (i.e., activated) on the modem stack associated with the second SIM. As described, persistent PDN connections may be maintained for some commonly-used PDNs, and therefore may be activated when the request for activity is detected.

In response to determining that a connection to the PDN corresponding to the packet-switched service of the request is activated (i.e., determination block 418=“No”), the wireless device processor may establish a new connection with the corresponding PDN on the modem stack associated with the second SIM in block 420. In some examples, establishing the new PDN connection may involve establishing a default bearer with the corresponding PDN.

In block 422, the wireless device processor may perform the requested activity on the modem stack associated with the second SIM. Depending on the signaling involved for the particular data-oriented service and/or policies set forth by the second network, performing the requested activity may require establishing one or more additional bearers with the corresponding PDN.

Once the activity is completed, the wireless device processor may instruct the modem stack associated with the second SIM to release control of the RF resource in block 424. That is, the modem stacks associated with the first and second SIMs may revert to perfuming normal contention for access to the RF resource, depending on the particular communication needs of each.

In determination block 426 the wireless device processor may determine whether the corresponding PDN is selected for a persistent connection on the modem stack associated with the second SIM (e.g., in block 410).

In response to determining that the corresponding PDN is selected for a persistent PDN connection (i.e., determination block 426=“Yes”), the wireless device processor may maintain the corresponding PDN connection on the modem stack associated with the second SIM in block 428.

In response to determining that the corresponding PDN is not selected for a persistent PDN connection (i.e., determination block 426=“No”), the wireless device processor may deactivate the corresponding PDN connection in block 430. For example, the wireless device processor may trigger a PDN disconnect procedure between the modem stack associated with the second SIM and the second network.

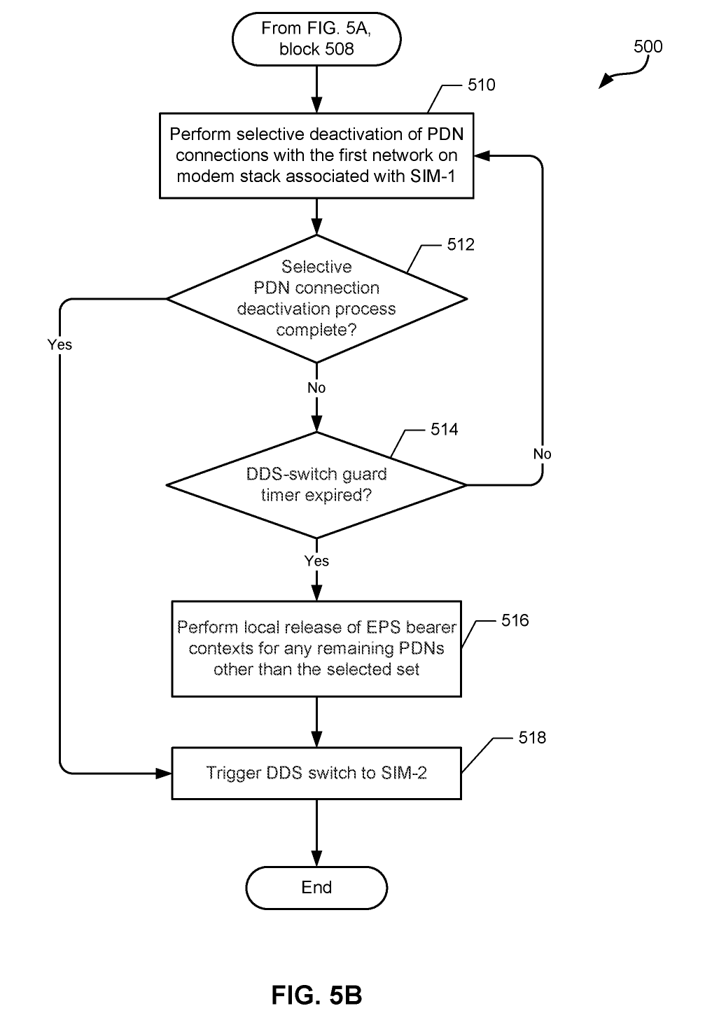

FIGS. 5A-5B illustrate a method 500 for implementing an improved protocol for performing a DDS switch on a MSMS wireless communication device according to various examples. With reference to FIGS. 1-5B, the operations of the method 400 may be implemented by one or more processors of a wireless device, such as the wireless communication device 200. The one or more processors may include, for example, a general purpose processor 206 and/or a baseband modem processor(s) 216, or a separate controller (not shown) that may be coupled to the memory 214 and to the baseband modem processor(s) 216.

While the descriptions of the various examples address PDN connections for two SIMs associated with one RF resource, the various example processes may be implemented for SIM functions on more than two SIMs (e.g., three SIMs, four SIMs, etc.). Further, the use of more than two SIMs in various examples may involve sharing more than one RF resource (e.g., two shared RF resources, three shared RF resources, etc.). Again, references to the first SIM (“SIM-1”) and associated modem stack, and the second SIM (“SIM-2”) and associated modem stack, are arbitrary and used merely for the purposes of describing the examples. The wireless device processor may assign any indicator, name, or other designation to differentiate the SIMs, associated modem stacks, and network resources. Further, example methods may apply the same regardless of the mobility state of each SIM and/or communication activity on the modem stack associated with each SIM.

In method 500, the wireless device processor may perform the operations in blocks 402-412 of the method 400. As described, the wireless device processor may identify a first SIM and second SIM as each supporting LTE, with the first SIM as the current DDS camped in and/or attached to a first packet-switched network (e.g., blocks 402-404). The wireless device processor may perform a network attach procedure on the modem stack associated with the second SIM in a second packet-switched network (e.g., block 406), and perform operations to establish any persistent PDN connections on the modem stack associated with the second SIM (e.g., blocks 408-412). In this manner, device-oriented service may be available for communications with the second SIM, regardless of its non-DDS status.

In block 502, the wireless device processor may detect an input indicating a user's selection, such as through the device settings, of another (i.e., second) SIM as the DDS.

In determination block 504, the wireless device processor may determine whether the modem stack associated with the first SIM is participating in an active voice communication, which may be repeated so long as the RRC connection with the first network has not been released (i.e., determination block 504=“No”).

In response to determining that the wireless device processor associated with the first SIM is not participating in an active voice communication (i.e., determination block 504=“No”), the wireless device processor may trigger the start of a selective PDN connection deactivation process on the modem stack associated with the first SIM in block 506.

In block 508, the wireless device processor may start a DDS-switch guard timer for the modem stack associated with the first SIM. That is, in order to avoid unnecessary delay, a predetermined maximum amount of time is set in which to complete deactivation of the PDN connections with the first network.

In block 510, the wireless device processor may perform selective deactivation of PDN connections with the first network on the modem stack associated with the first SIM. In particular, instead of releasing all PDN connections, the wireless device processor may remain attached to the first network and may maintain a set of selected PDNs. For example, an IMS PDN may be maintained, as well as an internet PDN connection if the first network supports WLAN local breakout for internet service. Further, any PDN connection that is the sole PDN connection in the first network may be maintained. Additional PDN connections may be deactivated by the wireless device processor, such as by performing a PDN disconnect procedure.

The wireless device processor may determine whether the selective PDN connection deactivation process is completed in determination block 512.

In response to determining that the selective PDN connection deactivation process is not completed (i.e., determination block 512=“No”), the wireless device processor may determine whether the DDS switch guard timer has expired in determination block 514.

In response to determining that the DDS switch guard timer has not expired (i.e., determination block 514=“No”), the wireless device processor may continue to perform selective deactivation of PDN connections with the first network on the modem stack associated with the first SIM in block 514.

In response to determining that the DDS switch guard timer has expired (i.e., determination block 514=“Yes”), the wireless device processor may perform a local release of bearer contexts for remaining PDNs other than the selected set in block 516.

In response to determining that selective PDN connection deactivation process is completed (i.e., determination block 512=“Yes”), the wireless device processor may trigger a DDS switch to the second SIM in block 518. In various examples, the modem stack associated with the second SIM may already be registered in the second network as described. Therefore, the DDS switch may be performed by updating DDS information in application interfaces, and modifying corresponding routing tables on the wireless communication device.

While the access networks are referenced as E-UTRAN and/or eNodeB(s), these references are also illustrative examples and the various examples may be implemented for receiving data in any of a variety of high-speed networks (e.g., HSPA+, DC-HSPA, EV-DO, etc.).

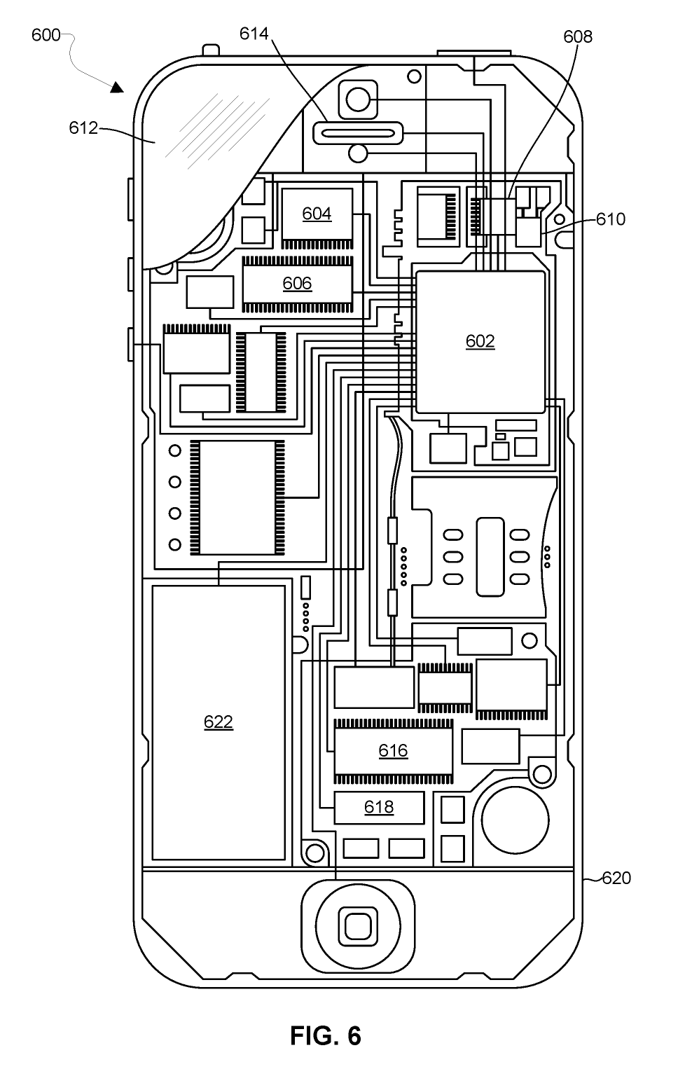

Various examples (including, but not limited to, the examples discussed above with reference to FIGS. 4A-5B) may be implemented in any of a variety of wireless devices, an example 600 of which is illustrated in FIG. 6. The wireless device 600 (which may correspond, for example, to the wireless devices 102 and/or 200 in FIGS. 1A-2) may include a processor 602 coupled to a touchscreen controller 604 and an internal memory 606. The processor 602 may be one or more multicore ICs designated for general or specific processing tasks. The internal memory 606 may be volatile or non-volatile memory, and may also be secure and/or encrypted memory, or unsecure and/or unencrypted memory, or any combination thereof.

The touchscreen controller 604 and the processor 602 may also be coupled to a touchscreen panel 612, such as a resistive-sensing touchscreen, capacitive-sensing touchscreen, infrared sensing touchscreen, etc. The wireless device 600 may have one or more radio signal transceivers 608 (e.g., Peanut®, Bluetooth®, Zigbee®, Wi-Fi, RF radio) and antennas 610, for sending and receiving, coupled to each other and/or to the processor 602. The transceivers 608 and antennas 610 may be used with the above-mentioned circuitry to implement the various wireless transmission protocol stacks and interfaces. The wireless device 600 may include a cellular network wireless modem chip 616 that enables communication via a cellular network and is coupled to the processor.

The wireless device 600 may include a peripheral device connection interface 618 coupled to the processor 602. The peripheral device connection interface 618 may be singularly configured to accept one type of connection, or multiply configured to accept various types of physical and communication connections, common or proprietary, such as USB, FireWire, Thunderbolt, or PCIe. The peripheral device connection interface 618 may also be coupled to a similarly configured peripheral device connection port (not shown). The wireless device 600 may also include speakers 614 for providing audio outputs. The wireless device 600 may also include a housing 620, constructed of a plastic, metal, or a combination of materials, for containing all or some of the components discussed herein. The wireless device 600 may include a power source 622 coupled to the processor 602, such as a disposable or rechargeable battery. The rechargeable battery may also be coupled to the peripheral device connection port to receive a charging current from a source external to the wireless device 600.

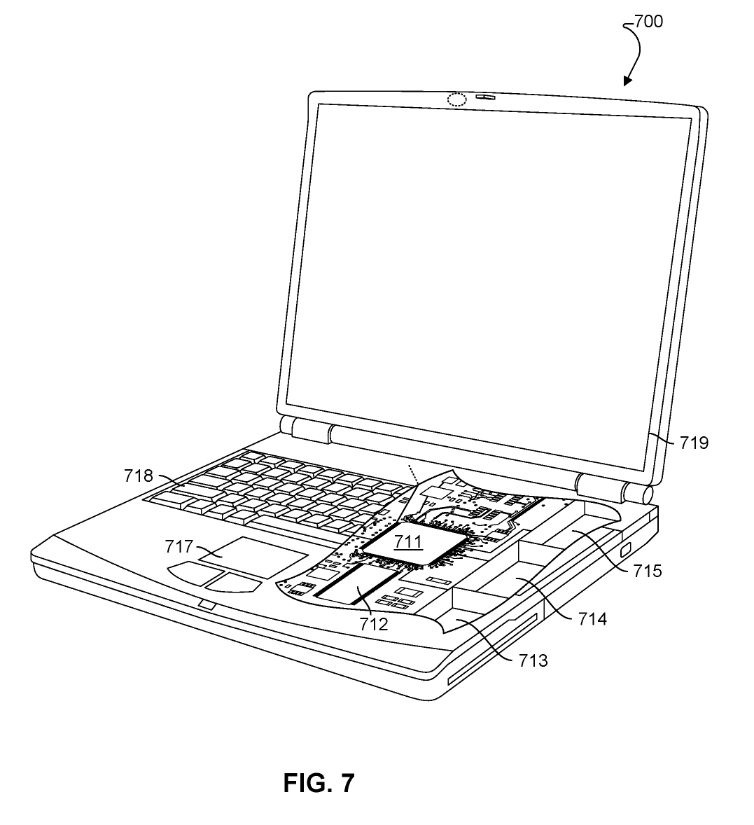

Various examples (including, but not limited to, the examples discussed above with reference to FIGS. 4A-5B), may also be implemented within a variety of personal computing devices, an example 700 of which is illustrated in FIG. 7. With reference to FIGS. 1A-7, the laptop computer 700 (which may correspond, for example, to the wireless devices 102, 200 in FIGS. 1A-2) may include a touchpad touch surface 717 that serves as the computer's pointing device, and thus may receive drag, scroll, and flick gestures similar to those implemented on wireless computing devices equipped with a touchscreen display and described above. A laptop computer 700 will typically include a processor 711 coupled to volatile memory 712 and a large capacity nonvolatile memory, such as a disk drive 713 of Flash memory. The computer 700 may also include a floppy disc drive 714 and a compact disc (CD) drive 715 coupled to the processor 711. The computer 700 may also include a number of connector ports coupled to the processor 711 for establishing data connections or receiving external memory devices, such as a Universal Serial Bus (USB) or FireWire® connector sockets, or other network connection circuits for coupling the processor 711 to a network. In a notebook configuration, the computer housing includes the touchpad 717, the keyboard 718, and the display 719 all coupled to the processor 711. Other configurations of the computing device may include a computer mouse or trackball coupled to the processor (e.g., via a USB input) as are well known, which may also be used in conjunction with various examples.

With reference to FIGS. 1A-7, the processors 602, 711 may be any programmable microprocessor, microcomputer or multiple processor chip or chips that can be configured by software instructions (applications) to perform a variety of functions, including the functions of various examples described above. In some devices, multiple processors may be provided, such as one processor dedicated to wireless communication functions and one processor dedicated to running other applications. Typically, software applications may be stored in the internal memory 606, 712, 713 before they are accessed and loaded into the processors 602, 711. The processors 602, 711 may include internal memory sufficient to store the application software instructions. In many devices the internal memory may be a volatile or nonvolatile memory, such as flash memory, or a mixture of both. For the purposes of this description, a general reference to memory refers to memory accessible by the processors 602, 711, including internal memory or removable memory plugged into the device and memory within the processor 602 and 711, themselves.

The foregoing method descriptions and the process flow diagrams are provided merely as illustrative examples and are not intended to require or imply that the steps of various examples must be performed in the order presented. As will be appreciated by one of skill in the art the order of steps in the foregoing examples may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

While the terms “first” and “second” are used herein to describe data transmission associated with a SIM and data receiving associated with a different SIM, such identifiers are merely for convenience and are not meant to limit the various examples to a particular order, sequence, type of network or carrier.

The various illustrative logical blocks, processes, circuits, and algorithm steps described in connection with the examples disclosed herein may be implemented as electronic hardware, computer software, or combinations of both. To clearly illustrate this interchangeability of hardware and software, various illustrative components, blocks, processes, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, processes, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof. If implemented in software, the functions may be stored as one or more instructions or code on a non-transitory computer-readable medium or non-transitory processor-readable medium. The steps of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed examples is provided to enable any person skilled in the art to make or use the present invention. Various modifications to these examples will be readily apparent to those skilled in the art, and the generic principles defined herein may be applied to other examples without departing from the spirit or scope of the invention. Thus, the present invention is not intended to be limited to the examples shown herein but is to be accorded the widest scope consistent with the following claims and the principles and novel features disclosed herein.

What is claimed is:

1. A method of facilitating support for packet-switched services in a multi-subscriber identity module (SIM) wireless communication device having at least two SIMs associated with a shared radio frequency (RF) resource, the method comprising:
detecting that a first SIM of the wireless communication device is set as a designated data subscription (DDS), wherein a modem stack associated with the first SIM receives information broadcast by a first network;
performing a network attach procedure with a second network on a modem stack associated with a second SIM, wherein a default packet data network (PDN) connection is established with the second network; and
setting the default PDN connection as a persistent PDN connection, wherein the modem stack associated with the second SIM maintains at least one persistent PDN connection.

2. The method of claim 1, further comprising:
detecting a request from at least one application to perform an activity using a packet-switched service on the modem stack associated with the second SIM;
allocating use of the RF resource to the modem stack associated with the second SIM;
determining whether a PDN connection corresponding to the packet-switched service associated with the at least one application is established on the modem stack associated with the second SIM; and
performing the requested activity in response to determining that a PDN connection corresponding to the packet-switched service associated with the at least one application is established on the modem stack associated with the second SIM.

3. The method of claim 2, wherein the packet-switched service associated with the at least one application is an operator-specific service.

4. The method of claim 2, further comprising:
identifying commonly used PDNs on the modem stack associated with the second SIM;
selecting commonly used PDNs to be used as additional persistent PDN connections in the second network; and
establishing the additional persistent PDN connections on the modem stack associated with the second SIM based on the selected commonly used PDNs.

5. The method of claim 4, further comprising:
detecting an end of the requested activity;
determining whether the PDN connection corresponding to the packet-switched service associated with the request is a persistent PDN connection; and
maintaining the corresponding PDN connection on the modem stack associated with the second SIM in response to determining that the PDN connection corresponding to the packet-switched service associated with the request is a persistent PDN connection.

6. The method of claim 5, further comprising:
deactivating the corresponding PDN connection on the modem stack associated with the second SIM in response to determining that the PDN connection corresponding to the packet-switched service associated with the request is not a persistent PDN connection.

7. The method of claim 1, wherein the modem stack associated with the second SIM maintains at least one additional persistent PDN connection.

8. The method of claim 7, wherein maintaining the at least one persistent PDN connection comprises establishing one or more Evolved Packet System (EPS) bearers with a commonly used PDN.

9. The method of claim 1, further comprising:
detecting a user input to switch the DDS;
evaluating PDN connections on the modem stack associated with the first SIM;
starting a DDS-switch guard timer;
performing a selective PDN connection deactivation process on the modem stack associated with the first SIM based on the evaluation;
detecting that the DDS-switch guard timer is expired or the selective PDN connection deactivation process is complete; and
updating a DDS selection in application interfaces on the wireless communication device.

10. The method of claim 9, wherein evaluating PDN connections on the modem stack associated with the first SIM comprises:
identifying any current PDN connections in the first network; and
identifying a set of PDN connections to be maintained on the modem stack associated with the first SIM.

11. The method of claim 10, wherein the set of PDN connections to be maintained includes any connection to an IP multimedia subsystem (IMS) PDN.

12. The method of claim 10, further comprising:
determining whether the first network supports access to a packet core over wireless local area network (WLAN),
wherein the set of PDN connections to be maintained includes any connection to an Internet PDN in response to determining that the first network supports access to a packet core over WLAN.

13. The method of claim 10, further comprising:
performing a local release of a bearer context for each remaining PDN connection that is not part of the identified set in response to detecting that the DDS-switch guard timer is expired.

14. A wireless communication device, comprising:
a memory;
a shared radio frequency (RF) resource; and
a processor coupled to the memory and the shared RF resource, wherein the processor is configured to connect to at least a first subscriber identity module (SIM) and a second SIM, and wherein the processor is configured with processor-executable instructions to:
detect that the first SIM is set as a designated data subscription (DDS), wherein a modem stack associated with the first SIM receives information broadcast by a first network;
perform a network attach procedure with a second network on a modem stack associated with the second SIM, wherein a default packet data network (PDN) connection is established with the second network;
detect a request from at least one application to perform an activity using a packet-switched service on the modem stack associated with the second SIM;
set the default PDN connection as a persistent PDN connection, wherein the modem stack associated with the second SIM maintains at least one persistent PDN connection.

15. The wireless communication device of claim 14, wherein the processor is further configured with processor-executable instructions to:
detect a request from at least one application to perform an activity using a packet-switched service on the modem stack associated with the second SIM;
allocate use of the RF resource to the modem stack associated with the second SIM;
determine whether a PDN connection corresponding to the packet-switched service associated with for the at least one application is established on the modem stack associated with the second SIM; and
perform the requested activity in response to determining that a PDN connection corresponding to the packet-switched service associated with the at least one application is established on the modem stack associated with the second SIM.

16. The wireless communication device of claim 15, wherein the packet-switched service associated with the at least one application is an operator-specific service.

17. The wireless communication device of claim 15, wherein the processor is further configured with processor-executable instructions to:
identify commonly used PDNs on the modem stack associated with the second SIM;
select commonly used PDNs to be used as additional persistent PDN connections in the second network; and
establish the additional persistent PDN connections on the modem stack associated with the second SIM based on the selected commonly used PDNs.

18. The wireless communication device of claim 17, wherein the processor is further configured with processor-executable instructions to:
detect an end of the requested activity;
determine whether the PDN connection corresponding to the packet-switched service associated with the request is a persistent PDN connection; and
maintain the corresponding PDN connection on the modem stack associated with the second SIM in response to determining that the PDN connection corresponding to the packet-switched service associated with the request is a persistent PDN connection.

19. The wireless communication device of claim 18, wherein the processor is further configured with processor-executable instructions to:
deactivating the corresponding PDN connection on the modem stack associated with the second SIM in response to determining that the PDN connection corresponding to the packet-switched service associated with the request is not a persistent PDN connection.

20. The wireless communication device of claim 14, wherein the modem stack associated with the second SIM maintains at least one additional persistent PDN connection.

21. The wireless communication device of claim 20, wherein the processor is further configured with processor-executable instructions to maintain the at least one persistent PDN connection comprises establishing one or more Evolved Packet System (EPS) bearers with a commonly used PDN.

22. The wireless communication device of claim 14, wherein the processor is further configured with processor-executable instructions to:
detect a user input to switch the DDS;
evaluate PDN connections on the modem stack associated with the first SIM;
start a DDS-switch guard timer;
perform a selective PDN connection deactivation process on the modem stack associated with the first SIM based on the evaluation;
detect that the DDS-switch guard timer is expired or the selective PDN connection deactivation process is complete; and
update a DDS selection in application interfaces on the wireless communication device.

23. The wireless communication device of claim 22, wherein the processor is further configured with processor-executable instructions to evaluate PDN connections on the modem stack associated with the first SIM by:
identifying any current PDN connections in the first network; and
identifying a set of PDN connections to be maintained on the modem stack associated with the first SIM.

24. The wireless communication device of claim 23, wherein the set of PDN connections to be maintained includes any connection to an IP multimedia subsystem (IMS) PDN.

25. The wireless communication device of claim 23, wherein the processor is further configured with processor-executable instructions to:
determine whether the first network supports access to a packet core over wireless local area network (WLAN),
wherein the set of PDN connections to be maintained includes any connection to an Internet PDN in response to determining that the first network supports access to a packet core over WLAN.

26. The wireless communication device of claim 23, wherein the processor is further configured with processor-executable instructions to:
perform a local release of a bearer context for each remaining PDN connection that is not part of the identified set in response to detecting that the DDS-switch guard timer is expired.

27. A wireless communication device, comprising:
a radio frequency (RF) resource configured to connect to at least two subscriber identity modules (SIMs);
means for detecting that a first SIM of the wireless communication device is set as a designated data subscription (DDS), wherein a modem stack associated with the first SIM receives information broadcast by a first network;
means for performing a network attach procedure with a second network on a modem stack associated with a second SIM, wherein a default packet data network (PDN) connection is established with the second network; and
means for setting the default PDN connection as a persistent PDN connection, wherein the modem stack associated with the second SIM maintains at least one persistent PDN connection.

28. The wireless communication device of claim 27, further comprising:
means for detecting a request from at least one application to perform an activity using a packet-switched service on the modem stack associated with the second SIM;
means for allocating use of the RF resource to the modem stack associated with the second SIM;
means for determining whether a PDN connection corresponding to the packet-switched service associated with the at least one application is established on the modem stack associated with the second SIM; and
means for performing the requested activity in response to determining that a PDN connection corresponding to the packet-switched service associated with the at least one application is established on the modem stack associated with the second SIM.

29. The wireless communication device of claim 28, further comprising:
means for identifying commonly used PDNs on the modem stack associated with the second SIM;
means for selecting commonly used PDNs to be used as additional persistent PDN connections in the second network; and
means for establishing the additional persistent PDN connections on the modem stack associated with the second SIM based on the selected commonly used PDNs.

30. A non-transitory processor-readable storage medium having stored thereon processor-executable instructions configured to cause a processor of a wireless communication device configured with a shared radio frequency (RF) resource associated with at least two subscriber identity modules (SIMs) to perform operations comprising:
detecting that a first SIM is set as a designated data subscription (DDS), wherein a modem stack associated with the first SIM receives information broadcast by a first network;
performing a network attach procedure with a second network on a modem stack associated with a second SIM, wherein a default packet data network (PDN) connection is established with the second network; and
setting the default PDN connection as a persistent PDN connection, wherein the modem stack associated with the second SIM maintains at least one persistent PDN connection.
